(19) United States
(12) Patent Application Publication
(10) Pub. No.: US 2018/0032392 A1
(43) Pub. Date: Feb. 1, 2018

(54) DATA BUS INVERSION CONTROLLER AND SEMICONDUCTOR DEVICE INCLUDING THE SAME

(71) Applicant: SK hynix Inc., Icheon-si Gyeonggi-do (KR)

(72) Inventors: Jae Woong YUN, Seoul (KR); Yong Mi KIM, Hwaseong-si Gyeonggi-do (KR); Chang Hyun KIM, Seoul (KR)

(73) Assignee: SK hynix Inc., Icheon-si Gyeonggi-do (KR)

(21) Appl. No.: 15/487,930

(22) Filed: Apr. 14, 2017

(30) Foreign Application Priority Data
Jul. 29, 2016 (KR) 1020160096586

(51) Int. Cl. G06F 11/07; G06F 11/30; G06F 11/34

(52) U.S. Cl. CPC G06F 11/0787; G06F 11/349; G06F 11/3027; G06F 11/0745

(57) ABSTRACT

A DBI (Data Bus Inversion) controller may be provided. The DBI controller may include an address generation circuit configured to generate a DBI address from an input address. The DBI controller may include a DBI flag signal input and output (input/output) circuit configured to input/output a DBI flag signal in order to write the DBI flag signal to a memory cell corresponding to the DBI address or read the DBI flag signal from the memory cell corresponding to the DBI address, based on a command.

### CROSS-REFERENCES TO RELATED APPLICATION

The present application claims priority under 35 U.S.C. § 119(a) to Korean application number 10-2016-0096586, filed on Jul. 29, 2016, in the Korean Intellectual Property Office, which is incorporated herein by reference in its entirety.

### BACKGROUND

### 1. Technical Field

Various embodiments may generally relate to a DBI (Data Bus Inversion) controller capable of controlling an input and output (input/output) of data processed through a DBI function, and a semiconductor device including the same.

### 2. Related Art

In general, a semiconductor device consists of a plurality of output buffers corresponding to the number of output data, in order to perform a data output operation. Each of the data output buffers includes a MOS transistor for performing an output operation, and the MOS transistor is switched in response to an input of data and outputs the data to the outside.

The state of the MOS transistor is determined according to the logic value of input data. For example, when data having a high-level logic value is transmitted to a data output buffer including an NMOS transistor, the NMOS transistor is turned on. Thus, a current flow is generated between the drain and source of the NMOS transistor. With the increase in number of transistors generating a current flow among the plurality of NMOS transistors installed in the respective data output buffers, a current loss of a semiconductor integrated circuit is increased, thereby reducing power efficiency.

The DBI function is a technique that determines how much data among a predetermined unit number of data (for example, eight data) generate a current flow in a transistor of a data output buffer, and inverts data having a logic value at which a current flow is generated when the number of the data is high, in order to reduce a current loss. For example, when the data output buffer includes an NMOS transistor, a current flow is generated in the NMOS transistor in a case where data is at a high level. Thus, when the number of high-level data among the eight data is equal to or more than five, the data is inverted and transmitted to the data output buffer, and when the number of high-level data among the eight data is less than five, the data is not inverted but transmitted to the data output buffer.

In order to perform such an operation, a transmitter-side semiconductor device consists of a DBI flag signal generator which determines whether the number of data having a logic value at which a current flow is generated is high, and generates a DBI flag signal. That is, when the DBI flag signal is enabled, the DBI controller inverts data transmitted to the data output buffer and outputs the inverted data, and when the DBI flag signal is disabled, the DBI controller does not invert data but transmits the data to the data output buffer. Furthermore, the DBI flag signal is outputted with data, and indicates whether the data was inverted.

When a reception-side semiconductor device receives data processed through the DBI function, the reception-side semiconductor device recovers the data to the original data according to the DBI flag signal, and stores the recovered data. However, since a processing time is required to recover the data, the entire speed of the reception-side semiconductor device may be reduced while a large amount of current is consumed. Furthermore, while the data is recovered, an error may occur.

### SUMMARY

In an embodiment of the present disclosure, a data bus inversion (DBI) controller may be provided. The DBI controller may include an address generation circuit configured to generate a DBI address from an input address. The DBI controller may include a DBI flag signal input and output (input/output) circuit configured to input/output a DBI flag signal in order to write the DBI flag signal to a memory cell corresponding to the DBI address or read the DBI flag signal from the memory cell corresponding to the DBI address, based on a command.

In an embodiment of the present disclosure, a semiconductor device may be provided. The semiconductor device may include a DBI controller and a memory cell. The DBI controller s may include a DBI address generation circuit configured to generate a DBI address corresponding to an input address. The DBI controller may include a DBI flag signal input/output circuit configured to input/output a DBI flag signal in order to write the DBI flag signal to the DBI address of the memory cell or read the DBI flag signal from the DBI address of the memory cell, based on a command received by the DBI controller.

In an embodiment of the present disclosure, a semiconductor device may include a memory cell including a normal region and an ECC (Error Correction Code) region. The semiconductor device may include a DBI controller configured to receive a DBI flag signal and write the received signal to the ECC region of the memory cell, based on a write command.

### BRIEF DESCRIPTION OF THE DRAWINGS

FIG. 1 is a configuration diagram of an example of a representation of a semiconductor device,

FIG. 2A is a flowchart illustrating a representation of an example of a data flow of the semiconductor device of FIG. 1 during a write operation.

FIG. 2B is a flowchart illustrating a representation of an example of a data flow of the semiconductor device of FIG. 1 during a read operation.

FIG. 3 is a configuration diagram of an example of a representation of a semiconductor device according to an embodiment.

FIG. 4 is a diagram illustrating a representation of an example of an address matching table according to the embodiment.

FIG. 5A is a flowchart illustrating a representation of an example of a data flow of the semiconductor device of FIG. 3 during a write operation.

FIG. 5B is a flowchart illustrating a representation of an example of a data flow of the semiconductor device of FIG. 3 during a read operation.

FIG. 6 is a configuration diagram of a representation of an example of a semiconductor device according to an embodiment.

FIG. 7 is a diagram illustrating a representation of an example of an address matching table according to an embodiment.

FIG. 8 is a configuration diagram of an example of a representation of a semiconductor system according to an embodiment.

### DETAILED DESCRIPTION

Hereinafter, a data bit inversion (DBI) controller and a semiconductor device including the same according to the present disclosure may be described below with reference to the accompanying drawings through examples of embodiments.

Various embodiments may be directed to a DBI controller capable of improving a processing speed required for recovering data, reducing an operating current, and lowering an error occurrence probability, when storing data processed through a DBI function.

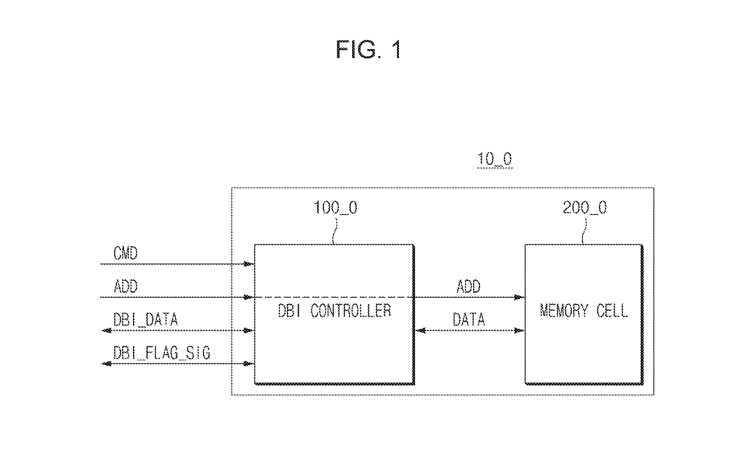

FIG. 1 is a configuration diagram of a semiconductor device 10_0 including a DBI controller 100_0.

The semiconductor device 10_0 of FIG. 1 includes the DBI controller 100_0 and a memory cell 200_0.

When a command CMD such as a write command is inputted, the DBI controller 100_0 recovers input data DBI_DATA to the original data according to a DBI flag signal DBI_FLAG_SIG. The DBI controller 100_0 stores the recovered data DATA in the memory cell 200_0.

For example, data DBI_DATA is inputted to the DBI controller 100_0. The input data DBI_DATA is data processed through the DBI function, and may correspond to the original data or data obtained by inverting the original data. The value of the DBI flag signal DBI_FLAG_SIG indicates whether the input data DBI_DATA is the original data or the data obtained by inverting the original data. For example, when the DBI flag signal DBI_FLAG_SIG is at a high level, it may indicate that the input data DBI_DATA is the data obtained by inverting the original data. Furthermore, when the DBI flag signal DBI_FLAG_SIG is at a low level, it may indicate that the input data DBI_DATA is the original data. Further, the logic levels of the signals may be different from or the opposite of those described. For example, a signal described as having a logic “high” level may alternatively have a logic “low” level, and a signal described as having a logic “low” level may alternatively have a logic “high” level.

The DBI controller 100_0 generates data DATA by recovering the input data DBI_DATA to the state before the DBI process, and stores the generated data in the memory cell 200_0.

In the above-described example, when the DBI flag signal DBI_FLAG_SIG is at a high level, the DBI controller 100_0 generates data DATA by inverting the input data DBI_DATA, and stores the generated data in the memory cell 200_0.

On the other hand, when the DBI flag signal DBI_FLAG_SIG is at a low level, the DBI controller 100_0 generates data DATA having the value as the input data DBI_DATA, and stores the generated data in the memory cell 200_0.

When a command CMD such as a read command is inputted to the DBI controller 100_0, the DBI controller 100_0 reads data DATA from an input address ADD of the memory cell 200_0. The DBI controller 100_0 processes the data DATA through the DBI function, and outputs output data DBI_DATA and the DBI flag signal DBI_FLAG_SIG indicating whether the output data DBI_DATA was inverted.

For example, when the output data DBI_DATA corresponds to a value obtained by inverting the data DATA, the DBI controller 100_0 outputs the DBI flag signal DBI_FLAG_SIG at a high level. Furthermore, when the output data DBI_DATA has the same value as the data DATA, the DBI controller 100_0 outputs the DBI flag signal DBI_FLAG_SIG at a low level.

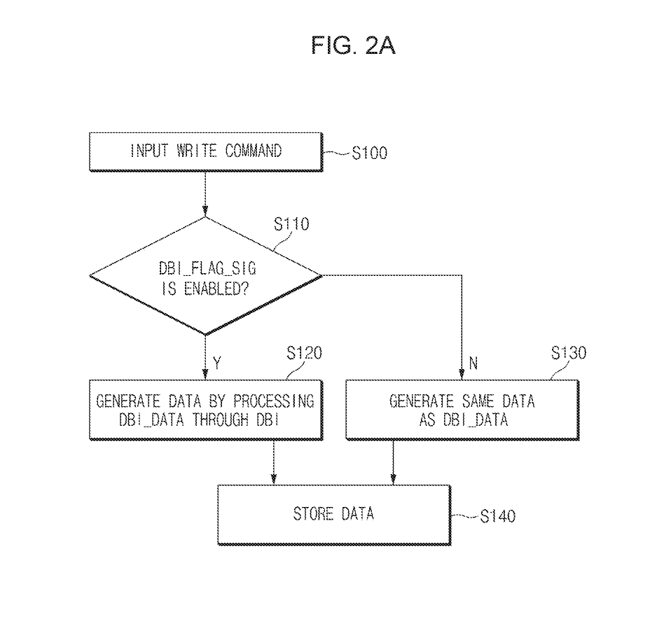

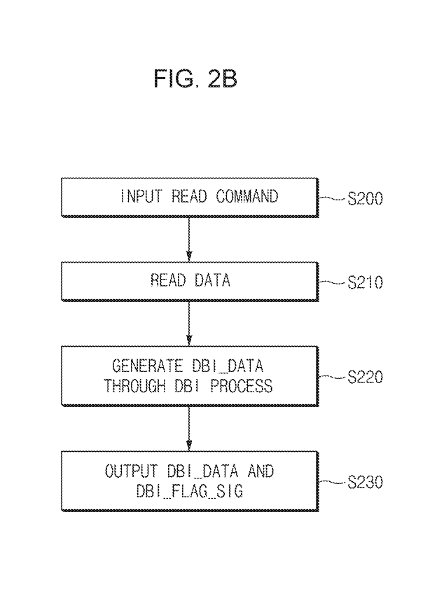

FIGS. 2A and 2B are flowcharts illustrating a data flow of the semiconductor device 10_0 of FIG. 1. FIG. 2A illustrates a case in which a write command is inputted, and FIG. 2B illustrates a case in which a read command is inputted.

First, the case in which a write command is inputted will be described with reference to FIG. 2A.

When a write command is inputted to the DBI controller 100_0 at step S100, the DBI controller 100_0 determines whether the DBI flag signal DBI_FLAG_SIG inputted with the input data DBI_DATA is enabled, at step S110.

When the DBI flag signal DBI_FLAG_SIG is enabled (Y at step S110), it may indicate that the input data DBI_DATA was inverted. Thus, the DBI controller 100_0 recovers the input data DBI_DATA to the state before the DBI process by inverting the respective bits of the input data DBI_DATA, and generates data DATA to store in the memory cell 200_0, at step S120.

When the DBI flag signal DBI_FLAG_SIG is not enabled (N at step S130), it may indicate that the input data DBI_DATA was not inverted. The DBI controller 100_0 generates data DATA having the same value as the input data DBI_DATA at step S130.

The DBI controller 100_0 stores the generated data DATA in the memory cell 200_0, at step S140.

Next, the case in which a read command is inputted will be described with reference to FIG. 2B.

When a read command is inputted at step S200, the DBI controller 100_0 reads data DATA from the memory cell 200_0 at step S210. Then, the DBI controller 100_0 processes the read data DATA through the DBI function, at step S220.

An example of the DBI process at step S220 is as follows. Suppose that the data DATA read from the memory cell 200_0 includes eight bits. When the number of high-level bits in the data DATA is equal to or more than five, the DBI controller 100_0 inverts the respective bits of the data DATA, and enables the DBI flag signal DBI_FLAG_SIG. When the number of high-level bits is equal to or less than four, the DBI controller 100_0 outputs the data DATA without inverting the data DATA, and disables the DBI flag signal DBI_FLAG_SIG. In an embodiment, the number of high-level bits in the data DATA may be equal to or more than a predetermined number or less than or equal to a predetermined number to enable the DBI flag signal DBI_FLAG_SIG or output the data DATA without inverting the data DATA, and as such the embodiments are not limited to the examples set forth above. In an embodiment, the data DATA read from the memory cell 200_0 may include any number of bits, and as such the embodiments are not limited in this way.

Finally, the DBI controller 100_0 outputs the data DBI_DATA processed through the DBI function and the DBI flag signal DBI_FLAG_SIG at step S230.

Through the DBI controller 100_0 having such a configuration, the semiconductor device 10_0 transmits the DBI data to the outside. At this time, since the number of low-level bits in the transmitted data becomes larger than the number of high-level bits, a current required for transmission can be reduced.

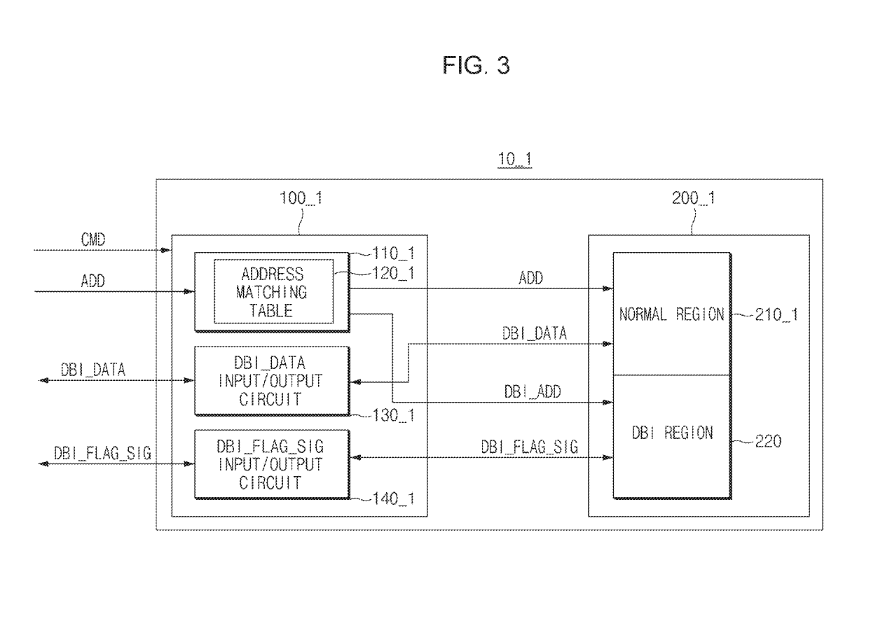

FIG. 3 is a configuration diagram of a semiconductor device 10_1 according to an embodiment.

The semiconductor device 10_1 of FIG. 3 includes a DBI controller 100_1 and a memory cell 200_1. The DBI controller 100_1 includes an address generation circuit 110_1, a DBI data input and output (input/output) circuit 130_1, and a DBI flag signal input and output (input/output) circuit 140_1.

The address generation circuit 110_1 outputs an input address ADD at which input data DBI_DATA is to be stored, without an additional process. The input address ADD indicates a normal region 210_1 of the memory cell 200_1, and is used for storing input data DBI_DATA processed through the DBI function.

The address generation circuit 110_1 generates a DBI address DBI_ADD corresponding to the input address ADD, using an address matching table 120_1 described later. The DBI address DBI_ADD indicates a DBI region 220 of the memory cell 200_1, and is used for storing a DBI flag signal DBI_FLAG_SIG. The DBI data input/output circuit 130_1 outputs the input data DBI_DATA processed through the DBI function to the memory cell 200_1 during a write operation. The input data DBI_DATA is stored in the normal region 210_1 of the memory cell 200_1 according to the input address ADD outputted from the address generation circuit 110_1.

The DBI data input/output circuit 130_1 outputs DBI data DBI_DATA stored in the normal region 210_1 of the memory cell 200_1 to the outside without an additional process, during a read operation. In an embodiment, the DBI data input/output circuit 130_1 is configured to read data processed through the DBI function from the input address ADD of the memory cell 200_1, and output the read data DBI_DATA without recovering the data DBI_DATA to a state before the DBI process.

The DBI flag signal input/output circuit 140_1 receives the DBI flag signal DBI_FLAG_SIG indicating whether the input data DBI_DATA is inverted, and outputs the received signal to the memory cell 200_1 without an additional process, during a write operation. The DBI flag signal DBI_FLAG_SIG is stored in the DBI region 220 of the memory cell 200_1 according to the DBI address DBI_ADD outputted from the address generation circuit 110_1. In an embodiment, the DBI data input/output circuit 130_1 is configured to receive input data DBI_DATA processed through a DBI function, and write the received data to the input address ADD of the memory cell 200_1 without recovering the data to a state before the DBI process.

The DBI flag signal input/output circuit 140_1 outputs the DBI flag signal DBI_FLAG_SIG stored in the DBI region 220 of the memory cell 200_1 to the outside without an additional process, during a read operation.

The semiconductor device 10_1 according to a present embodiment stores input data DBI_DATA in the memory cell 200_1 without an additional process, unlike the DBI controller 100_0 of FIG. 1.

The semiconductor device 10_1 according to a present embodiment stores the DBI flag signal DBI_FLAG_SIG in the DBI region 220 of the memory cell 200_1, the DBI flag signal DBI_FLAG_SIG indicating whether the input data DBI_DATA is inverted.

The memory cell 200_1 may separately include the DBI region 220 for storing the DBI flag signal DBI_FLAG_SIG, in addition to the normal region 210_1 for storing the input data DBI_DATA. That is, according to a present embodiment, the memory cell 200_1 stores the DBI flag signal DBI_FLAG_SIG as well as the input data DBI_DATA, the DBI flag signal DBI_FLAG_SIG indicating whether the input data DBI_DATA is inverted. Thus, the memory cell 200_1 additionally includes the DBI region 220 as a separate region for storing the DBI flag signal DBI_FLAG_SIG. In an embodiment, the DBI region 220 is distinct from the normal region 210_1.

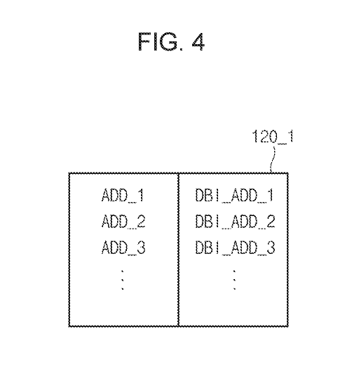

FIG. 4 illustrates the address matching table 120_1 included in the address generation unit 110_1.

Referring to FIG. 4, the address matching table 120_1 includes a DBI address DBI_ADD_1 matched to an input address ADD_1, a DBI address DBI_ADD_2 matched to an input address ADD_2, and a DBI address DBI_ADD_3 matched to an input address ADD_3. The DBI addresses DBI_ADD_1, DBI_ADD_2 and DBI_ADD_3 are used for storing DBI flag signals DBI_FLAG_SIG, DBI_FLAG_SIG 2 and DBI_FLAG_SIG3 in the DBI region 220 of the memory cell 200_1, the DBI flag signals DBI_FLAG_SIG, DBI_FLAG_SIG 2 and DBI_FLAG_SIG3 corresponding to input data DBI_DATA1, DBI_DATA_2 and DBI_DATA_3, respectively.

When a write command, an input address ADD, input data DBI_DATA and a DBI flag signal DBI_FLAG_SIG are inputted, the DBI controller 100_1 may store the DBI flag signal DBI_FLAG_SIG in the DBI region 220 of the memory cell 200_1 through the address generation circuit 110_1.

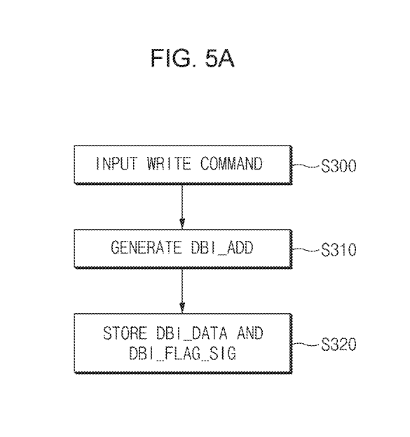

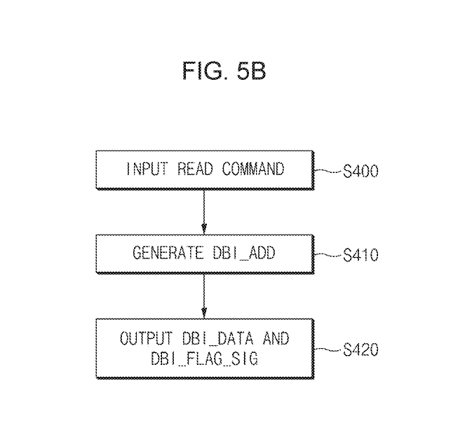

FIG. 5A is a flowchart illustrating a data flow of the semiconductor device 10_1 of FIG. 3 during a write operation.

As a command CMD, for example, a write command is inputted to the DBI controller 100_1 at step S300, a series of operations are started. At this time, an input address ADD, input data DBI_DATA, and a DBI flag signal DBI_FLAG_SIG are also inputted to the DBI controller 100_1.

The address generation circuit 110_1 included in the DBI controller 100_1 generates a DBI address DBI_ADD corresponding to the input address ADD, using the address matching table 120_1 of FIG. 4, at step S310.

The DBI controller 100_1 stores the input data DBI_DATA at the input address ADD without an additional process, and stores the DBI flag signal DBI_FLAG_SIG at the generated DBI address DBI_ADD, at step S320. In an embodiment, the input address ADD indicates the normal region 210_1 of the memory cell 200_1, and the DBI address DBI_ADD indicates the DBI region 220 of the memory cell 200_1.

According to an embodiment, the DBI controller 100_1 does not recover data DBI_DATA processed through the DBI function to the state before the DBI process, but stores the data DBI_DATA in the memory cell 200_1. Thus, the processing time can be shortened to improve the processing speed, and the error occurrence probability in the data processing process can be lowered.

Furthermore, since the DBI controller 100_1 stores the data DBI_DATA processed through the DBI function in the memory cell 200_1, the power consumption required for storing the data DBI_DATA can be reduced.

Referring back to FIG. 3, when command CMD, for example, a read command is inputted, the DBI controller 100_1 reads data DBI_DATA from the normal region 210_1 of the memory cell 200_1 corresponding to the input address ADD.

The address generation circuit 110_1 generates a DBI address DBI_ADD corresponding to the input address ADD in the same manner as the write command is inputted. In this example, the address generation circuit 110_1 uses the address matching table 120_1 of FIG. 4, in which the input address ADD and the DBI address DBI_ADD are matched to each other, in order to generate the DBI address DBI_ADD.

The DBI controller 100_1 reads a DBI flag signal DBI_FLAG_SIG from the DBI region 220 of the memory cell 200_1 corresponding to the DBI address DBI_ADD.

The DBI controller 100_1 outputs the data DBI_DATA read from the normal region 210_1 of the memory cell 200_1 and the DBI flag signal DBI_FLAG_SIG read from the DBI region 220 of the memory cell 200_1 to the outside, without an additional process. That is, the DBI controller 100_1 outputs the data DBI_DATA stored in the memory cell 200_1, without processing the data DBI_DATA through the DBI function, during a read operation.

FIG. 5B is a flowchart illustrating a data flow of the semiconductor device 10_1 of FIG. 3 during a read operation.

As a read command is inputted to the DBI controller 100_1 at step S400, a series of read operations are started. At this time, an input address ADD is also inputted to the DBI controller 100_1.

The address generation circuit 110_1 included in the DBI controller 100_1 generates a DBI address DBI_ADD corresponding to the input address ADD, using the address matching table 120_1 of FIG. 4, at step S410.

The DBI controller 100_1 reads data DBI_DATA from the normal region 210_1 of the memory cell 200_1 corresponding to the input address ADD. Furthermore, the DBI controller 100_1 reads a DBI flag signal DBI_FLAG_SIG from the DBI region 220 of the memory cell 200_1 corresponding to the generated DBI address DBI_ADD, at step S420. The DBI controller 100_1 outputs the data DBI_DATA and the DBI flag signal DBI_FLAG_SIG. In an embodiment, the DBI controller 100_1 outputs the data DBI_DATA and the DBI flag signal DBI_FLAG_SIG to the outside of the semiconductor device 10_1.

According to the present embodiment, the DBI controller 100_1 outputs the DBI data DBI_DATA read from the memory cell 200_1, without performing a DBI process on the data DBI_DATA processed through the DBI function. Thus, the processing time can be shortened to improve the processing speed, and the error occurrence probability in the data processing process can be lowered.

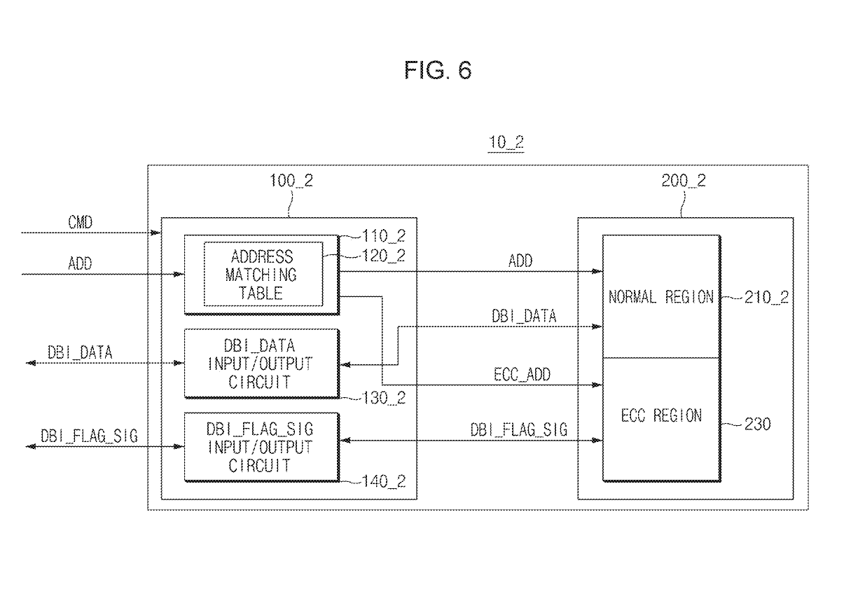

FIG. 6 is a diagram illustrating the architecture of a semiconductor device 10_2 according to an embodiment.

The semiconductor device 10_2 of FIG. 6 includes a DBI controller 100_2 and a memory cell 200_2. The DBI controller 100_2 includes an address generation circuit 110_2, a DBI data input/output circuit 130_2, and a DBI flag signal input/output circuit 140_2. The memory cell 200_2 includes a normal region 210_2 and an ECC (Error Correction Code) region 230. The ECC region 230 serves to store an ECC of data stored in the normal region 210_2. Such an ECC may be generated by a publicly known ECC generation method.

The DBI data input/output circuit 130_2, the DBI flag signal input/output circuit 140_2, and the normal region 210_2 of the memory cell 200_2, which are included in the semiconductor device 10_2 of FIG. 6, are configured in substantially the same manner as the DBI data input/output circuit 130_1, the DBI flag signal input/output circuit 140_1, and the normal region 210_1 of the memory cell 200_1 of the semiconductor device 10_1 of FIG. 3. Thus, descriptions thereof are omitted herein.

The address generation circuit 110_2 outputs an input address ADD for storing input data DBI_DATA processed through the DBI function, without an additional process. The input address ADD indicates the normal region 210_2 of the memory cell 200_2, and is used for storing the input data DBI_DATA processed through the DBI function.

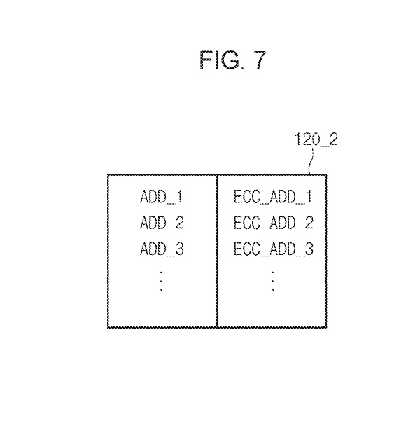

The address generation circuit 110_2 generates an ECC address ECC_ADD corresponding to the input address ADD, using an address matching table 120_2 described later. The ECC address ECC_ADD indicates the ECC region 230 of the memory cell 200_2. In an embodiment, the ECC address ECC_ADD is used for storing the DBI flag DBI_FLAG_SIG in the ECC region 230 of the memory cell 200_2. FIG. 7 is a diagram illustrating the address matching table 120_2 included in the address generation circuit 110_2.

The address matching table 120_2 includes ECC addresses ECC_ADD_1, ECC_ADD_2 and ECC_ADD_3 matched to input addresses ADD_1, ADD_2 and ADD_3, respectively. The ECC addresses ECC_ADD_1, ECC_ADD_2 and ECC_ADD_3 are used for storing the DBI flag signal DBI_FLAG_SIG in the ECC region 230 of the memory cell 200_2. When the input address ADD is determined according to the address matching table 120_2, the address generation circuit 110_2 may generate an ECC address ECC_ADD according to the input address ADD.

In an embodiment, the ECC region 230 is basically used for storing an ECC code of data stored in the normal region 210_2, and distinguished as a separate region 230 from the normal region 210_2. According to an embodiment, the ECC region 230 which is already allocated to store an ECC is used without the separate DBI region 220 as illustrated in FIG. 3. Thus, the memory cell 200_2 can be more efficiently used. In an embodiment, the normal region 210_2 is distinct from the ECC region 230.

The operation of the DBI controller 100_2 of FIG. 6 is performed in almost the same manner as the operation of the DBI controller 100_1. However, while the DBI controller 100_1 of FIG. 3 internally generates the DBI address DBI_ADD in order to write or read the DBI flag signal DBI_FLAG_SIG, the DBI controller 100_2 of FIG. 6 generates the ECC address ECC_ADD in order to store the DBI flag signal DBI_FLAG_SIG in the ECC region 230 of the memory cell 200_2.

For example, when a command CMD is a write command that is inputted, the address generation circuit 110_2 of the DBI controller 100_2 generates an ECC address ECC_ADD corresponding to an input address ADD.

The DBI controller 100_2 stores input data DBI_DATA in the normal region 210_2 of the memory cell 200_2 corresponding to the input address ADD. Furthermore, the DBI controller 100_2 stores a DBI flag signal DBI_FLAG_SIG in the ECC region 230 of the memory cell 200_2 corresponding to the ECC address ECC_ADD.

When a read command is inputted, the address generation circuit 110_2 of the DBI controller 100_2 generates an ECC address ECC_ADD corresponding to an input address ADD using the address matching table 120_2 of FIG. 7, in the same manner as the write command is inputted.

The DBI controller 100_2 reads data DBI_DATA from the normal region 210_2 of the memory cell 200_2 corresponding to the input address ADD, and reads a DBI flag signal DBI_FLAG_SIG from the ECC region 230 of the memory cell 200_2 corresponding to the ECC address ECC_ADD. The DBI controller 100_2 outputs the data DBI_DATA and the DBI flag signal DBI_FLAG_SIG to the outside. In an embodiment, the DBI controller 100_2 outputs the data DBI_DATA and the DBI flag signal DBI_FLAG_SIG to the outside of the semiconductor device 10_2.

According to an embodiment, the DBI controller 100_2 does not need to allocate part of the memory cell 200_1 to the DBI region 220, but can use the ECC region 230 allocated for ECC, in order to store the DBI flag signal DBI_FLAG_SIG. Thus, the DBI controller 100_2 can efficiently use the memory cell while suppressing an increase in capacity of the memory cell.

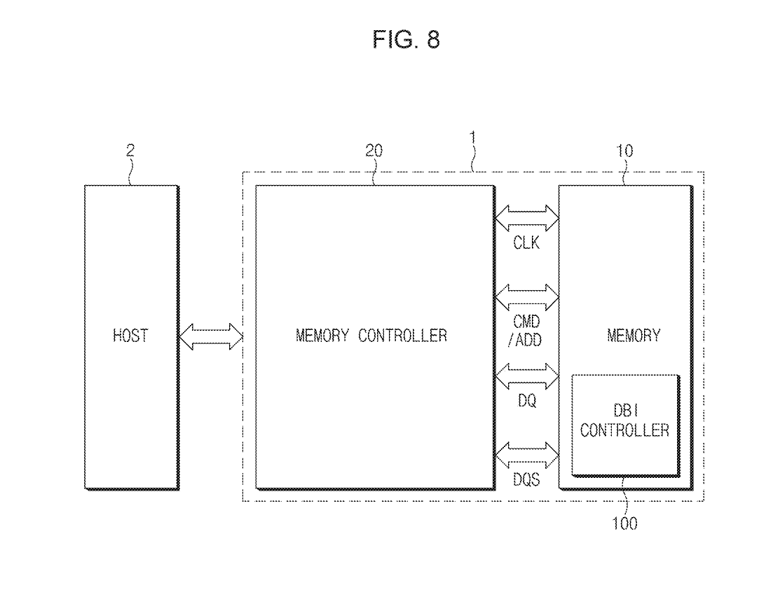

FIG. 8 is a configuration diagram of a semiconductor system including a DBI controller 100 according to an embodiment.

Referring to FIG. 8, the semiconductor system may include a host 2 and a memory system 1, and the memory system 1 may include a memory controller 20 and a memory 10. The memory 10 may include a semiconductor device 10_0 of FIG. 1, a semiconductor device 10_1 of FIG. 3 or a semiconductor device 10_2 of FIG. 6.

The host 2 may transmit a request and data to the memory controller 20, in order to access the memory 10. The host 2 may transmit data to the memory controller 20, in order to store the data in the memory 10. The host 2 may receive data outputted from the memory 10 through the memory controller 20. The memory controller 20 may provide data information, address information, memory setting information, a write request and a read request to the memory 10 in response to the request, and control the memory 10 to perform a write or read operation. The memory controller 20 may relay communication between the host 2 and the memory 10. The memory controller 20 may receive a request and data from the host 2, generate data DQ, a data strobe signal DQS, a command CMD, a memory address ADD and a clock CLK, and provide the data DQ, the data strobe signal DQS, the command CMD, the memory address ADD and the clock CLK to the memory 10, in order to control the operation of the memory 10. The memory controller 20 may provide data DQ and a data strobe signal DQS, which are outputted from the memory 10, to the host 2. The data DQ and the data strobe signal DQS correspond to the data DBI_DATA and the DBI flag signal DBI_FLAG_SIG of FIGS. 1, 3 and 6.

The memory 10 may include the above-described DBI controller 100. The DBI controller 100 represents the DBI controls 100_0, 100_1 and 100_2 of FIGS. 1, 3 and 6.

Thus, when a command CMD and memory address ADD are inputted from the memory controller 20, the DBI controller 100 generates a DBI address DBI_ADD corresponding to the memory address ADD. When a write command is inputted, the DBI controller 100 writes input data DBI_DATA and a DBI flag signal DBI_FLAG_SIG at an input address ADD and a DBI address DBI_ADD, respectively. When a read command is inputted, the DBI controller 100 reads the data DBI_DATA stored at the input address ADD and the DBI flag signal DBI_FLAG_SIG stored at the DBI address DBI_ADD from the memory 10, and transmits the read data and address to the memory controller 20.

FIG. 8 illustrates that the DBI controller 100 is included in the memory 10, but the DBI controller 100 may be positioned in the memory controller 20.

FIG. 8 illustrates that the host 2 and the memory controller 20 are physically separated from each other. However, the memory controller 20 may be included (embedded) in a processor such as a central processing unit (CPU) an application processor (AP) or a graphic processing unit (GPU) of the host 2 or embodied as one chip with the processors.

The memory 10 may receive a command CMD, a memory address signal ADD, data DQ, a data strobe signal DQS and a clock signal CLK from the memory controller 20, and perform a data receiving operation based on the signals.

The memory 10 may include a plurality of memory banks, and store the data DQ in a specific region among the banks of the memory, based on the memory address signal ADD. Furthermore, the memory 10 may perform a data transmitting operation based on the command CMD, the memory address signal ADD and the data strobe signal DQS which are received from the memory controller 20. The memory may data stored in a specific region of a memory bank to the memory controller 20, based on the address signal ADD, the data DQ and the data strobe signal DQS.

According to the present embodiments, the DBI controller and the semiconductor device can output data processed through the DBI function, thereby reducing current consumption during a transmission operation.

Furthermore, since the DBI controller and the semiconductor device store data processed through the DBI function without recovering the data, the power consumption required for storing the data can be reduced.

Furthermore, the DBI controller and the semiconductor device can store data processed through the DBI function without recovering the data to the original state, and output the stored data without processing the data through the DBI function. Thus, the time required for recovering the data or processing the data through the DBI function can be saved to thereby improve the processing speed.

Furthermore, the DBI controller and the semiconductor device can store data processed through the DBI function without recovering the data to the original state, and output the stored data without processing the data through the DBI function. Thus, the DBI controller and the semiconductor device can lower the probability that an error will occur while the data are recovered or processed through the DBI function.

While certain embodiments have been described above, it will be understood to those skilled in the art that the embodiments described are by way of example only. Accordingly, the semiconductor device described herein should not be limited based on the described embodiments. Rather, the semiconductor device described herein should only be limited in light of the claims that follow when taken in conjunction with the above description and accompanying drawings.

What is claimed is:

1. A data bus inversion (DBI) controller comprising:
an address generation circuit configured to generate a DBI address corresponding to an input address; and
a DBI flag signal input and output (input/output) circuit configured to input/output a DBI flag signal in order to write the DBI flag signal to a memory cell corresponding to the DBI address or read the DBI flag signal from the memory cell corresponding to the DBI address, based on a command received by the DBI controller.

2. The DBI controller according to claim 1, wherein the DBI flag signal input/output circuit receives the DBI flag signal and writes the received signal to the memory cell, based on a write command.

3. The DBI controller according to claim 2, further comprising a DBI data input/output circuit configured to receive input data processed through a DBI function, and write the received data to the input address of the memory cell without recovering the data to a state before the DBI process.

4. The DBI controller according to claim 1, wherein the address generation circuit generates the DBI address corresponding to the input address, using an address matching table.

5. The DBI controller according to claim 1, wherein the DBI flag signal input/output circuit reads the DBI flag signal from the memory cell and outputs the read signal, based on a read command.

6. The DBI controller according to claim 5, further comprising a DBI data input/output circuit configured to read data processed through the DBI function from the input address of the memory cell, and output the read data without recovering the data to a state before the DBI process.

7. A semiconductor device comprising:
a data bus inversion (DBI) controller; and
a memory cell,
wherein the DBI controller comprises:
an address generation circuit configured to generate a DBI address corresponding to an input address; and
a DBI flag signal input and output (input/output) circuit configured to input/output a DBI flag signal in order to write the DBI flag signal to the DBI address of the memory cell or read the DBI flag signal from the DBI address of the memory cell, based on a command received by the DBI controller.

8. The semiconductor device according to claim 7, wherein the address generation circuit generates the DBI address corresponding to the input address, using an address matching table.

9. The semiconductor device according to claim 7, wherein the DBI controller further comprises:
a DBI data input/output circuit configured to receive input data processed through a DBI function and write the received data to an input address of the memory cell without recovering the data to a state before the DBI process, or read data processed through the DBI function from the input address of the memory cell and output the read data without recovering the data to a state before the DBI process.

10. The semiconductor device according to claim 7, wherein the memory cell comprises a normal region where the input data processed through the DBI function is written and a DBI region where the DBI flag signal is written.

11. The semiconductor device according to claim 10, wherein in response to a write command,
the input data is written to the normal region of the memory cell corresponding to the input address, and the DBI flag signal is written to the DBI region of the memory cell corresponding to the DBI address, and
in response to a read command,
the input data is read from the input address of the normal region of the memory cell, and the DBI flag signal is read from the DBI address of the DBI region of the memory cell.

12. A semiconductor device comprising:
a memory cell comprising a normal region and an ECC (Error Correction Code) region; and
a data bus inversion (DBI) controller configured to receive a DBI flag signal and write the received signal to the ECC region of the memory cell, based on a write command.

13. The semiconductor device according to claim 12, wherein the DBI controller comprises an address generation circuit configured to generate an ECC address corresponding to an input address.

14. The semiconductor device according to claim 13, wherein the DBI controller writes the DBI flag signal to the ECC region of the memory cell corresponding to the ECC address.

15. The semiconductor device according to claim 12, wherein the DBI controller further comprises:
a DBI data input/output circuit configured to write input data processed through a DBI function to the normal region of the memory cell.

16. The semiconductor device according to claim 15, wherein the DBI data input/output circuit writes the input data without recovering the input data to a state before the DBI process.

17. The semiconductor device according to claim 13, wherein the address generation circuit generates the ECC address corresponding to the input address, using an address matching table.

18. The semiconductor device according to claim 12, wherein the DBI controller reads the DBI flag signal from the ECC region of the memory cell and outputs the read signal, based on a read command.

19. The semiconductor device according to claim 18, wherein the DBI controller reads data processed through the DBI function from the normal region of the memory cell corresponding to the input address, and outputs the read data.

20. The semiconductor device according to claim 19, wherein the DBI controller outputs the read data without recovering the data to a state before the DBI process.
